(19) United States
(12) Patent Application Publication
(10) Pub. No.: US 2013/0264031 A1
(43) Pub. Date: Oct. 10, 2013

(54) HEAT EXCHANGER WITH HEADERING SYSTEM AND METHOD FOR MANUFACTURING SAME

(71) Applicants: James F. Plourde, Stratham, NH (US); Theodor Mosidis, Lynnfield, MA (US); Benjamin Joseph Fichera, Newburyport, MA (US)

(72) Inventors: James F. Plourde, Stratham, NH (US); Theodor Mosidis, Lynnfield, MA (US); Benjamin Joseph Fichera, Newburyport, MA (US)

(21) Appl. No.: 13/442,531

(22) Filed: Apr. 9, 2012

(51) Int. Cl. F28F 9/02; B23P 15/26; F28D 15/00

(52) U.S. Cl. 165/104.11; 165/173; 29/890.03

(57) ABSTRACT

A heat exchanger with headering system is provided. The heat exchanger includes a body that extends between first and second headers. The central span of the body includes two sets of channels arranged in a checkerboard pattern to provide efficient heat transfer between heat transfer fluids in each set. End portions of the body, within the headers, include offsets that transition the sets of channels from a linear alignment to the checkerboard pattern. This configuration allows heat exchange fluids to be introduced into the appropriate sets of channels through the headers with less complexity. A method of manufacturing the heat exchanger is also provided.

### BACKGROUND OF THE INVENTION

Heat exchangers are used to remove excess heat from a variety of applications. Some heat exchangers employ adjacent flows of hot and cold heat exchange fluids through channels or passages to transfer heat from the hot fluid to the cold fluid. Some heat exchanger configurations include flat tubes through which the fluids flow. Fins may be provided within and/or outside the tubes to increase the surface area available for heat transfer. A headering system is provided to introduce heat exchange fluids into and withdraw the fluids from the body of the heat exchanger.

### SUMMARY OF THE INVENTION

A heat exchanger with headering system is provided. The heat exchanger includes a body that extends between first and second headers. The central span of the body includes two sets of channels arranged in a checkerboard pattern to provide efficient heat transfer between heat transfer fluids in each set. End portions of the body, within the headers, include offsets that transition the sets of channels from a vertical linear alignment to the checkerboard pattern. This configuration allows heat exchange fluids to be introduced into the appropriate sets of channels through the headers efficiently and with less complexity.

In one embodiment, a heat exchanger includes a body comprising a longitudinally extending central span and first and second end portions. First and second headers are attached to the end portions of the body. Each header includes a housing and first and second chambers disposed within the housing in longitudinal alignment with the central span. Ports for inlet and outlet of fluid are formed in at least one header.

The body of the heat exchanger includes first and second sets of a plurality of channels within the body, each channel having open ends located at the first and second end portions. Along the central span of the body, the channels of the first set and the channels of the second set form a checkerboard pattern in cross section, with walls of each channel of one of the sets shared with walls of adjacent channels of the other of the sets. Within the first and second end portions of the body, the channels include offsets that transition the channels from the checkerboard pattern to a configuration in which the open ends of the channels of each set alternate in linearly alignment in cross section. Also within the first and second end portions, the channels of one set extend longitudinally beyond the channels of the other set so that the open ends of one set terminate at one of the chambers and the open ends of the other set terminate at the other of the chambers.

A method of manufacturing the heat exchanger is provided. In one embodiment, the method includes extruding a material into a longitudinally extending body piece, with a plurality of aligned channels extending through the body. The longitudinally extending body piece is cut into a plurality of segments. Each segment is bent at opposite ends within a plane through the aligned rows to form an offset at each end. The segments are stacked into a stack with the offsets of each segment arranged in alternating directions, the plurality of channels aligned in parallel within a central span. The segments in the stack are joined to form an integral body. Sections of the end portions of alternating planes of channels are removed. Headers are attached at each end of the body.

### DESCRIPTION OF THE DRAWINGS

The invention will be more fully understood from the following detailed description taken in conjunction with the accompanying drawings in which:

FIG. 1 is an isometric view of one embodiment of a heat exchanger with headering system;

FIG. 2 is a partial exploded view of the heat exchanger of FIG. 1;

FIG. 3 is a cross sectional view taken along line of FIG. 1;

FIG. 4 is a partial cut-away view of the headering system of FIG. 1;

FIG. 5 is a further partial cut-away view of the headering system of FIG. 1;

FIG. 6 is an end view of a stack of extruded segments of the heat exchanger of FIG. 1;

FIG. 7 is an isometric view of a stack of extruded segments illustrating an intermediate stage in a method of manufacturing the heat exchanger of FIG. 1;

FIG. 8 is an isometric view illustrating the offsets of the heat exchanger of FIG. 1;

FIG. 9 is a plan view of an extruded segment illustrating another stage in a method of manufacturing the heat exchanger of FIG. 1;

FIG. 10 is a partial isometric view of the extruded segment of FIG. 9;

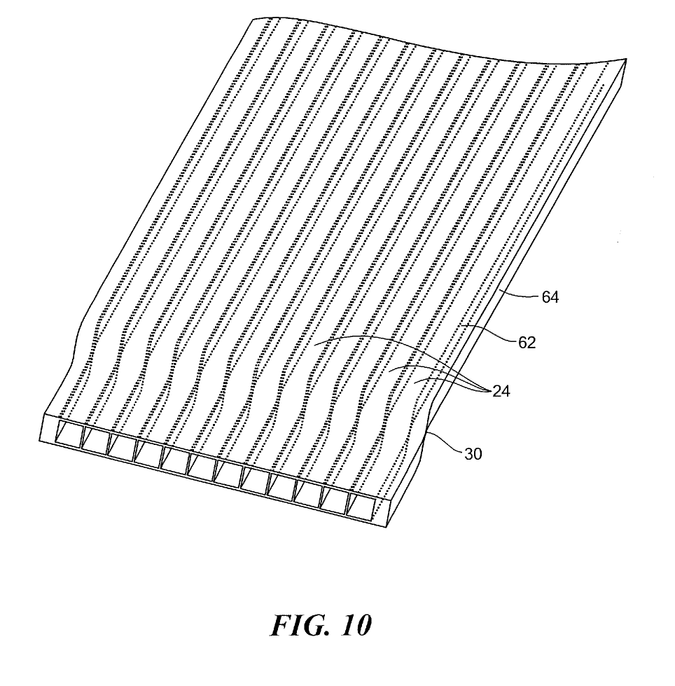

FIG. 11 is an isometric view of a stack of extruded segments illustrating a further intermediate stage in a method of manufacturing the heat exchanger;

FIG. 12 is an isometric view of a further embodiment of a heat exchanger with a two-pass headering system; and

FIG. 13 is an exploded isometric view of a header of the heat exchanger of FIG. 12.

### DETAILED DESCRIPTION OF THE INVENTION

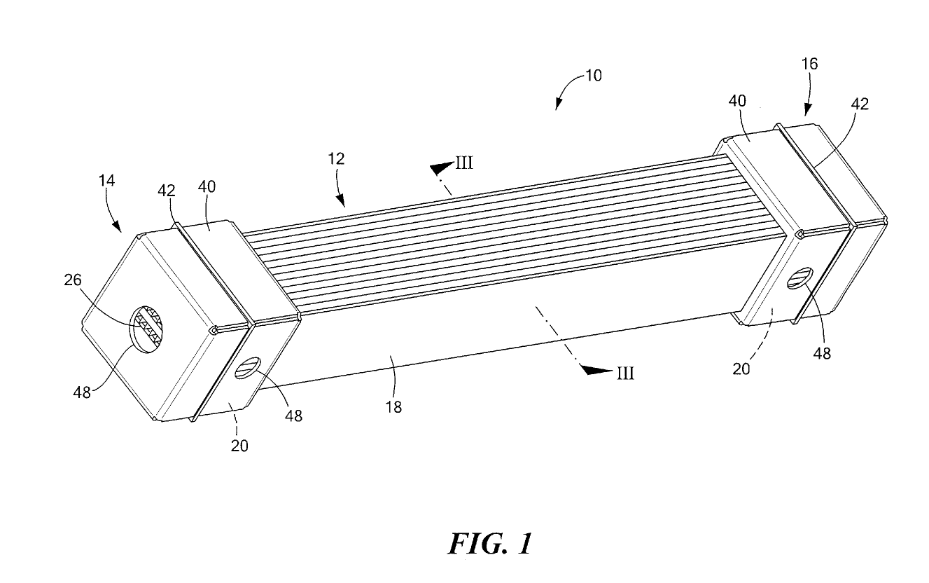

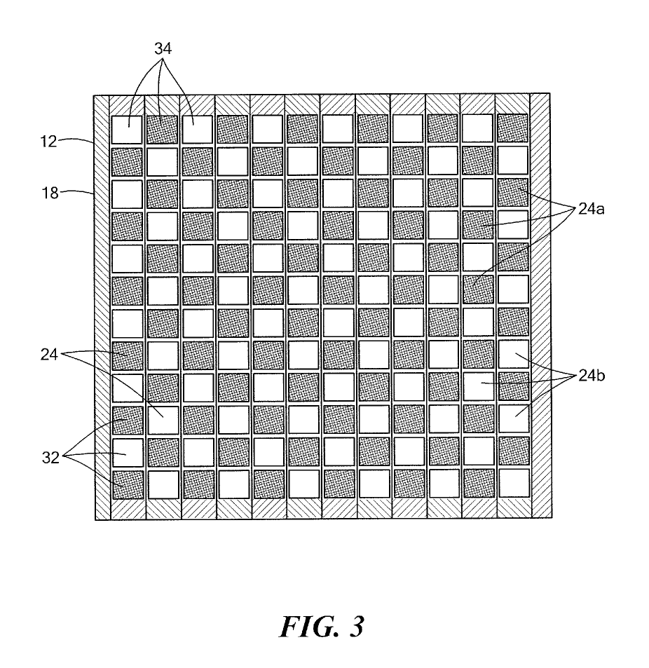

One embodiment of a heat exchanger with headering system is illustrated in FIGS. 1-5. The heat exchanger 10 includes a body 12 attached to first and second headers 14, 16 at each end. The body includes a longitudinally extending central span 18 and first and second end portions 20. A plurality of longitudinally extending channels 24 extends through the body between open ends 26 at the first and second end portions 20. Along the central span 18, the channels are aligned in parallel and form an array of rows 32 and columns 34 when viewed in cross section. (See FIG. 3.) The channels are grouped into two sets 24a, 24b, one set receiving a hotter heat exchange fluid and the other set receiving a cooler heat exchange fluid. (For clarity, set 24a is illustrated with a darker shading in the figures.) Along the central span 18, the sets form a checkerboard pattern in cross section, such that the walls of each channel 24a in one set share or abut walls of adjacent channels 24b in the other set and vice versa. When the hotter heat exchange fluid flows through a first set of channels and the cooler heat exchange fluid flows through a second set of channels, heat transfer from the hotter to the cooler fluid occurs through the shared or abutting walls of each channel. In this manner, the surface area available for heat transfer within the central span 18 is greater than in heat exchangers in which the hotter and cooler fluids flow in alternating layers, leading to greater heat transfer efficiency.

Additionally, heat exchange fluid can be introduced in a counterflow pattern through adjacent channels. That is, fluid flow through any one channel 24a within the central span 18 is counter to, or in the opposite direction of fluid flow through the abutting channels 24b. Because the hotter fluid and the cooler fluid are flowing in counter or opposite directions, the heat transfer can be more efficient than if the hotter and cooler fluids were flowing in the same direction.

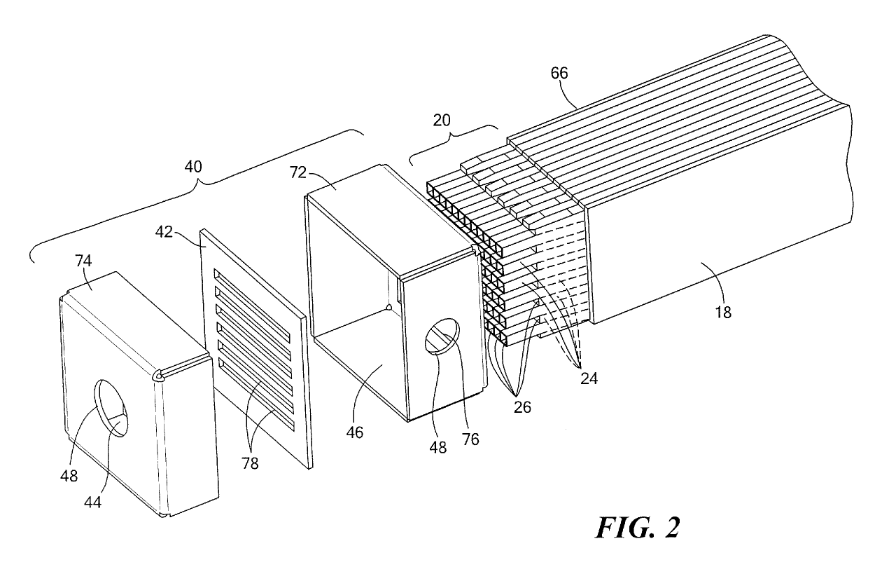

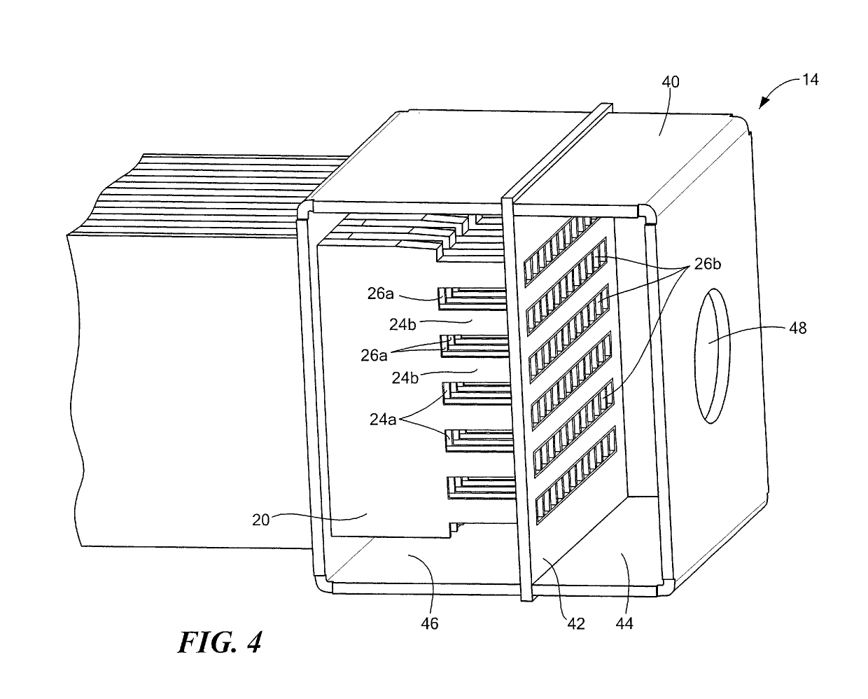

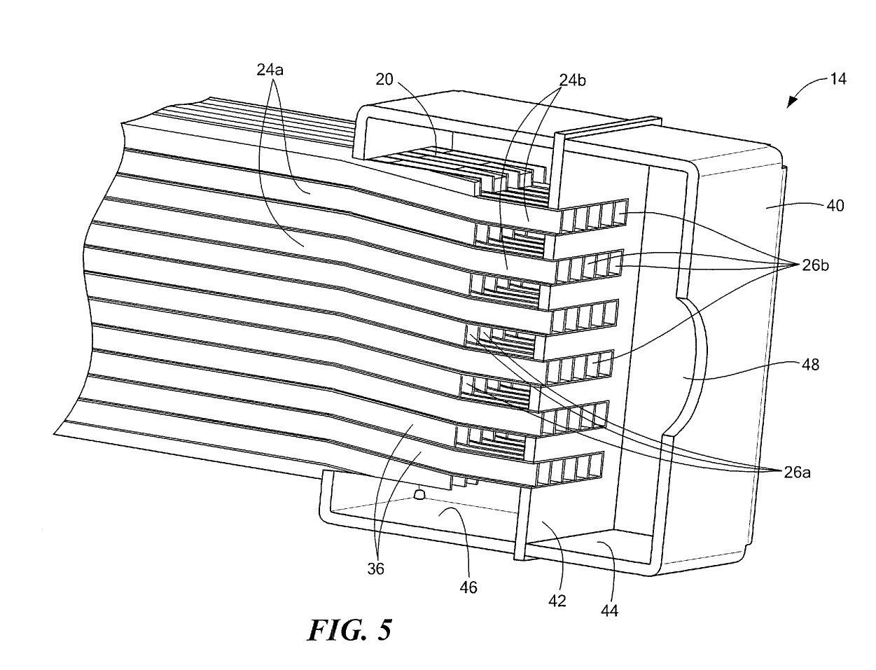

Referring also to FIGS. 4 and 5, the first and second end portions 20 of the body 12 are attached to the first and second headers 14, 16 for introducing fluid into the channels 24. (Only one header, for example, header 14, is shown in FIGS. 4 and 5; the other header 16 can be identical.) Each header 14, 16 includes a housing 40. A partition wall or tube sheet 42 in the interior of the housing partitions the header into two chambers or manifolds 44, 46, typically an inlet chamber and an outlet chamber. Each chamber includes a port or aperture 48 for fluid inlet and outlet. (See also FIGS. 1 and 2.) Appropriate inlet and outlet fittings (not shown) can be attached to the ports to introduce fluid into the chambers or withdraw fluid from the chambers, as would be known by those of skill in the art. In another embodiment, in which the hot and cold fluids flow in the same direction, one header can include two inlet chambers and the other header can include two outlet chambers.

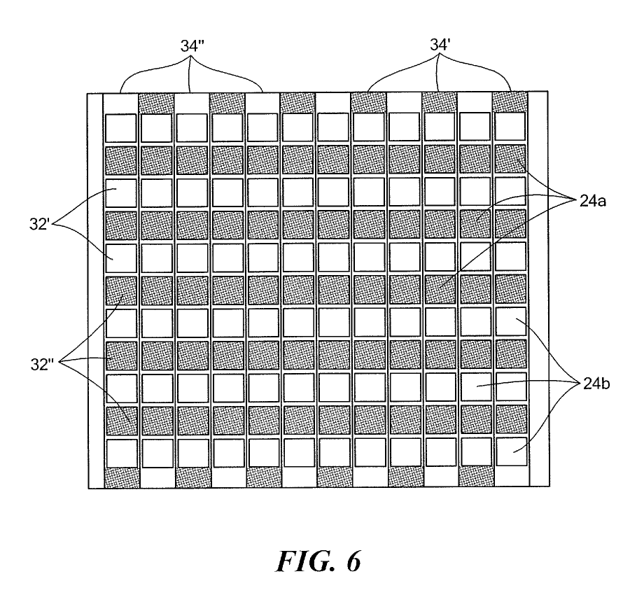

Within the first and second end portions 20 of the body 12, the channels 24 transition from the checkerboard pattern of the central span 18 to a configuration that allows the heat exchange fluids to be introduced into the appropriate channels through the headers 14, 16 with less complexity. More particularly, the planes or columns 34 of channels 24 are formed with alternating in-plane offsets 30 that transition the channels from the checkerboard pattern of the central span to a configuration in which the channels 24a, 24b of each set are linearly aligned in cross section in rows 32′, 32″ orthogonal to the columns 34. See also FIG. 6. Thus, within the end portion 20, the open ends 26a of one set alternate in linear alignment with the open ends 26b of the other set. Additionally, the channels in one set extend longitudinally beyond the channels in the other set for fluid communication with separate chambers 44, 46 within the headers. For example, referring to FIGS. 4 and 5, channels 24a terminate at the inner chamber 46 of the first header 14, and channels 24b terminate at the outer chamber 44 of the first header 14.

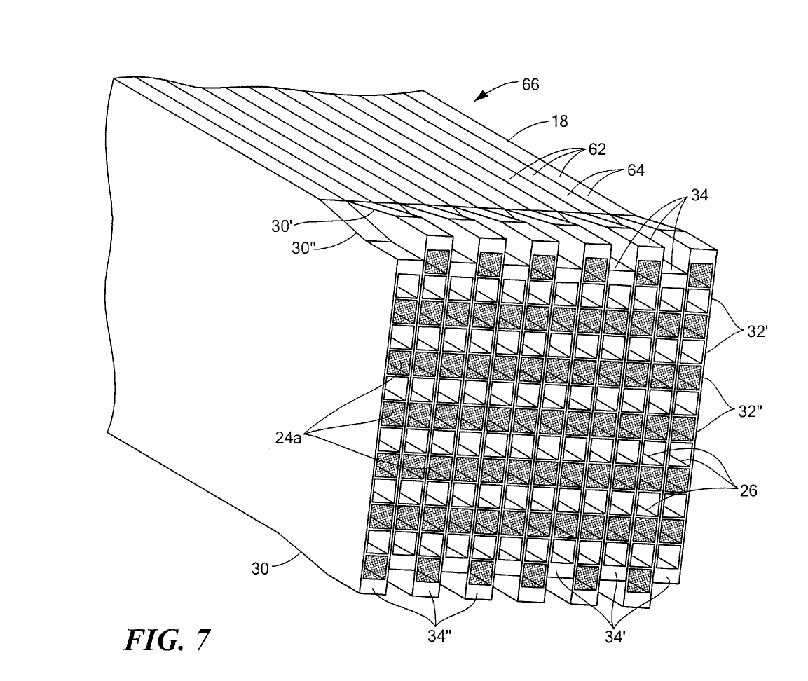

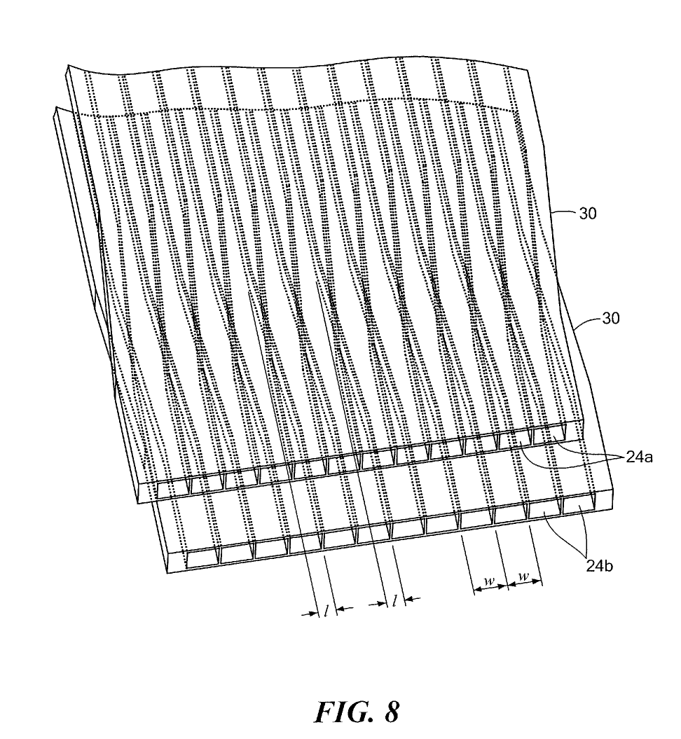

Adjacent planes or columns 34 of channels have offsets 30 that alternate direction, best illustrated in FIGS. 7 and 8, which show intermediate stages in one method of manufacturing the heat exchanger. For example, the columns 34′ of channels have an offset 30′ in one direction, and the alternating columns 34″ of channels have an offset 30″ in the opposite direction. In this manner, the offsets 30′, 30″ of the columns of channels alternate directions through the stack. Also, the distance 1 of the offset 30 in each column is one-half the width dimension w of a channel 24, as indicated in FIG. 8. Thus, within the central span 18 of the channels between the headers, the channels 24a of one set come to overlie the channels 24b of the other set, forming the checkerboard pattern described above.

An analogous arrangement occurs to transition the channels from the checkerboard pattern to a linear alignment in the second header 16.

In operation, a hotter heat exchange fluid is introduced into, for example, the first set of the channels 24a through the inlet chamber 46 of the first header 14, flows the length of the central span 18, and is withdrawn through the outlet chamber of the second header 16. A cooler heat exchange fluid is introduced into the second set of the channels 24b through the inlet chamber of the second header 16, flows the length of the central span counter to the hotter fluid flow, and is withdrawn through the outlet chamber 44 of the first header 14. Along the central span 18, the hotter fluid is in heat exchange relationship with the cooler fluid through all four walls of each channel. It will be appreciated that which set of channels 24a, 24b receives the hotter heat exchange fluid and which the cooler heat exchange fluid is determined by the application. Similarly, which chambers are used for fluid input and which for fluid output are also determined by the application.

Any suitable heat exchange fluid, such as water or an oil, can be used. The hotter fluid and the cooler fluid can be the same fluid, or they can be different fluids. Each fluid can be in either the liquid or the gaseous state. The phase of the fluid can transform from gaseous to liquid or from liquid to gaseous within the channels if desired, depending on the heat transfer application.

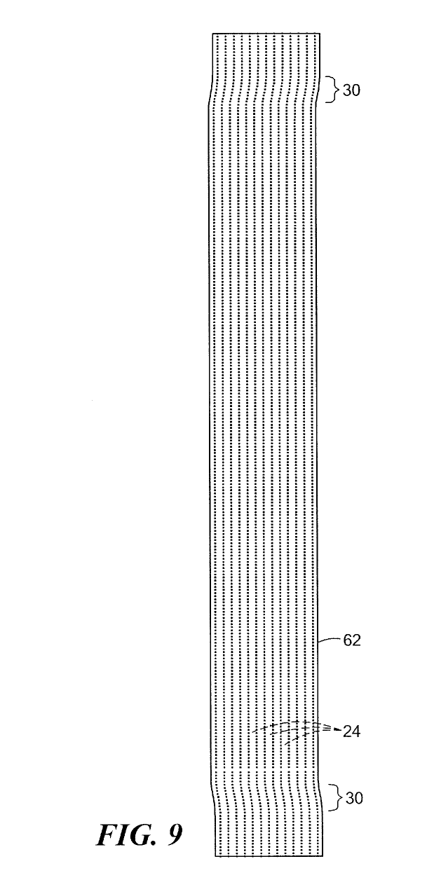

The heat exchanger with headering system can be manufactured in any suitable manner. In one example, the heat exchanger can be manufactured as follows. A plane or column 34 of channels 24 is formed as an extrusion. Generally, a suitable material, such as a metal, is extruded into a longitudinally extending body piece with a plurality of channels in a linear alignment extending through the body piece. Forming each plane of channels as a unitary extrusion aids in minimizing leakage from the heat exchanger during operation. The extrusion is cut into a plurality of individual segments 62 each of an appropriate length. See FIG. 9.

Each extruded segment 62 is bent at each end within the plane of the channels to provide the offset 30. See FIGS. 8 and 9. The distance 1 of the offset is one-half the width dimension w of a channel, as illustrated in FIG. 7. A plurality of such segments with offsets at each end are produced, depending on the size of the heat exchanger. The bending can be accomplished using an appropriate jig or in any other suitable manner.

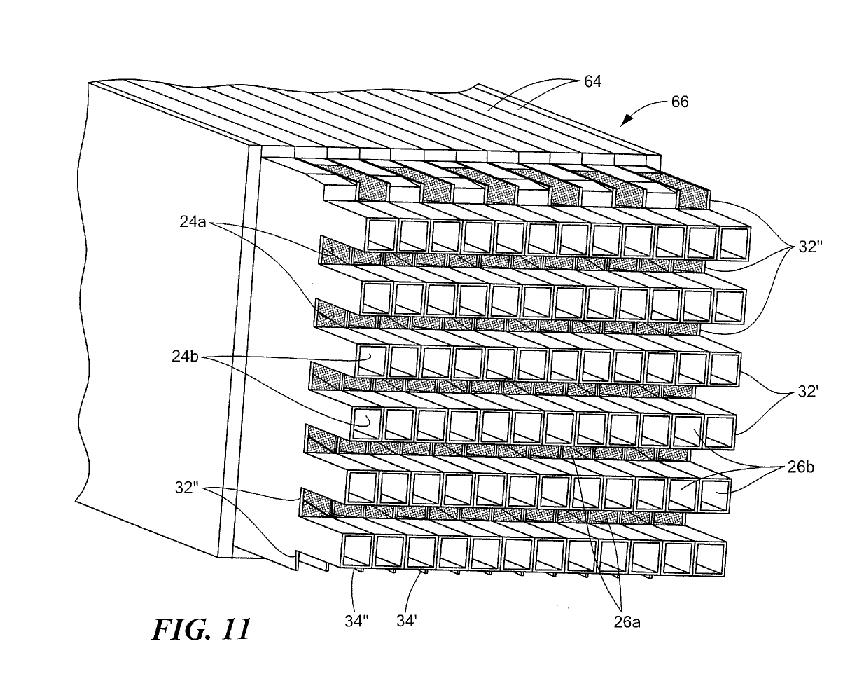

The plurality of segments 62 are then stacked up, preferably with the edges 64 along the central span 18 of each segment in alignment, and with the offsets 30′, 30″ alternating by column 34, as illustrated in FIG. 7. The stack 66 is then joined to form an integral part that cannot be disassembled, such as by brazing, welding, or another suitable technique. Next, sections of the end portions of every other row 32″ of channels are removed by a suitable process, such as electrical discharge machining or another machining or removal process, thereby leaving the channels 24b in rows 32′ to extend beyond the channels 24a, in rows 32″ as illustrated in FIG. 11.

The header housings 40 are formed in any suitable manner. For example, for each housing, the tube sheet 42 and two sections 72, 74 to define the chambers 44, 46 are cut from a sheet of suitable metal. An opening 76 sized to receive the stack of extrusions is cut in the inner chamber section 72. Openings for inlet and outlet ports 48 are cut in each chamber section. Slots 78 sized to support rows of the extended channels 24b are cut in the tube sheet. The chamber sections 72, 74 are formed by bending into the shape of the housing.

The stack 66 of segments 62 is inserted at each end portion 20 into the opening 76 in the innermost chamber section 72 of the housing. The extended channels 24a are inserted into or adjacent the slots 78 of the tube sheet 24. The outermost chamber section 74 of the housing is placed against the partition wall 42. See FIGS. 1 and 2. The entire assembly is integrally joined, for example, by brazing, welding, or another suitable technique. Appropriate inlet and outlet fittings are fixed within the ports of the header.

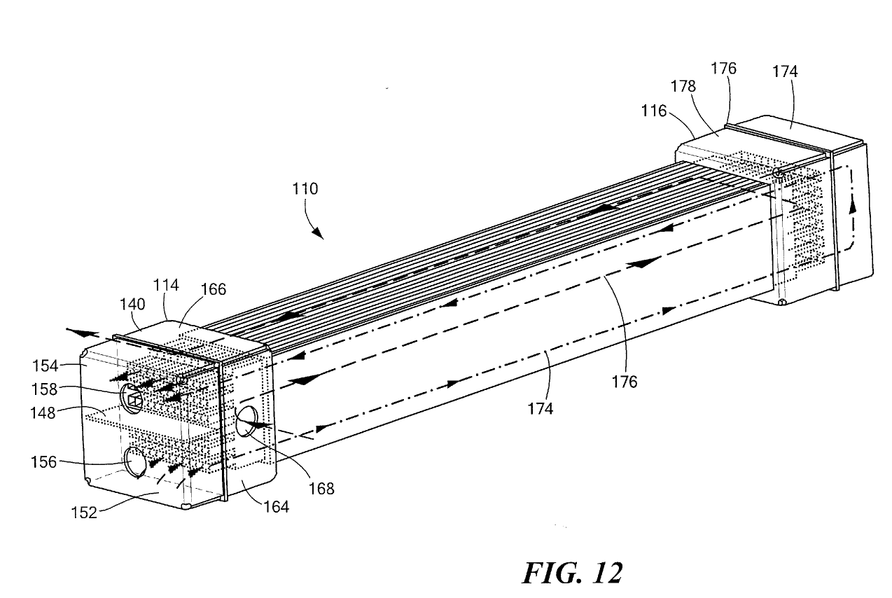

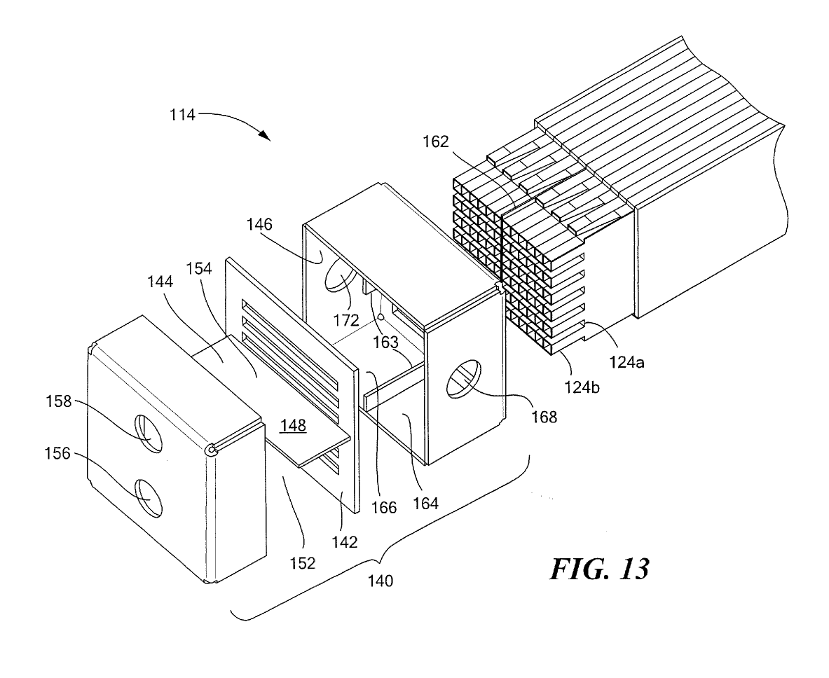

In another embodiment, a two-pass heat exchanger 110 with headering system is provided, illustrated in FIGS. 12 and 13. A header 114 at one end includes inlet and outlet ports for both heat exchange fluids and additional dividers to partition the chamber for each fluid into inlet and outlet chambers. The header 116 at the other end contains no ports or additional dividers.

More particularly, the header 114 includes an outer chamber 144 and an inner chamber 146. The outer chamber 144 is further partitioned by an outer divider 148 into an outer inlet chamber 152 and an outer outlet chamber 154 for a first heat exchange fluid. The outer divider 148 is attached to tube sheet 142 at, for example, a midpoint between extended channels 124b and to inner walls of the housing 140. The outer inlet chamber 152 includes an inlet port 156, and the outer outlet chamber 154 includes an outlet port 158.

The inner chamber 146 is partitioned into an inner inlet chamber 164 and an inner outlet chamber 166 by an inner divider 162 located between channels 124 and orthogonal to the outer divider 148. The inner divider 162 can be formed by, for example, leaving a rib when removing the end portions of every other row of channels 124a, as described above. Side dividers 163 can be formed on inner walls of the housing 140 to join with edges of the inner divider 162 to complete the partitioning of the inner chamber 146. The inner inlet chamber 164 includes an inlet port 168, and the inner outlet chamber 166 includes an outlet port 172.

In operation, a first heat exchange fluid, indicated schematically by a dashed line 174 in FIG. 12, enters the outer inlet chamber 152 through the inlet port 156. From this chamber, the first fluid flows into and along the length of a portion, for example, one-half, of the channels 124b. The fluid exits the channels 124b at the outer chamber 174 of the header 116, turns on the far side of the tube sheet 176, and enters and flows along the length of the other portion of the channels 124b. The fluid then exits the channels 124b and flows into the outer outlet chamber 154 and exits the heat exchanger through the outlet port 158. A second heat exchange fluid, indicated schematically by a solid line 176, enters the inner inlet chamber 164 through the inlet port 168, flows along a portion, for example, one-half, of the channels 124a, exits at the inner chamber 178 of the header 116, turns on the near side of the tube sheet 176, and returns along the other portion of the channels 124a. The second fluid exits the channels 124a, flows into the inner outlet chamber 166, and exits the heat exchanger through the inner outlet port 172. In this manner, half of the fluids flow in a counterflow pattern (in opposite directions) through adjacent channels of the heat exchanger, while the other half of the fluids flow in the same direction through adjacent channels.

Suitable materials for the heat exchanger body and headers include metals such as aluminum, an aluminum alloy, copper, a copper alloy, steel, stainless steel, titanium, or a titanium alloy, although other metals can be used. Plastic materials can also be used.

The present heat exchanger can be readily manufactured. The heat exchanger obviates the need for complicated fin geometries to increase the surface area within rows, as in prior art heat exchangers. The heat exchange fluid(s) can be introduced into the channels with less complexity.

It will be appreciated that the reference to rows and columns is for convenience of description and does not refer to an orientation of the heat exchanger during manufacture or in operation. Although the channels are shown with square cross sections, other cross sectional shapes are possible, such as rectangular, hexagonal. The segments or individual rows of channels can be formed in other ways, such as by forming a sheet or sheets of metal into the appropriate shapes. The invention is not to be limited by what has been particularly shown and described, except as indicated by the appended claims.

What is claimed is:

1. A heat exchanger comprising:
a body comprising a longitudinally extending central span and first and second end portions, and
a first header attached to the first end portion of the body, a second header attached to the second end portion of the body, each header comprising a housing, a first chamber and a second chamber disposed within the housing and arranged in longitudinal alignment with the central span, and fluid inlet ports and fluid outlet ports formed in at least one of the first header and the second header;
wherein the body further comprises:
a first set of a plurality of channels disposed within the body, each channel having open ends located at the first and second end portions,
a second set of a plurality of channels disposed within the body, each channel having open ends located at the first and second end portions,
along the central span of the body, the channels of the first set and the channels of the second set form a checkerboard pattern in cross section, with walls of each channel of one of the sets shared with walls of adjacent channels of the other of the sets;
within the first and second end portions of the body, the channels include offsets that transition the channels from the checkerboard pattern to a configuration in which the open ends of the channels of each set are linearly aligned in cross section, the open ends of each set alternating in linearly alignment with the open ends of the other set,
within the first and second end portions, the channels of one set extend longitudinally beyond the channels of the other set, and
within each header, the open ends of one of the sets terminate at one of the chambers and the open ends of the other of the sets terminate at the other of the chambers.

2. The heat exchanger of claim 1, wherein within the first and second end portions, the offsets alternate in direction from one plane of channels to the next adjacent plane of channels.

3. The heat exchanger of claim 1, wherein the distance of the offsets within each plane of channels is equivalent to half of the width of a channel.

4. The heat exchanger of claim 1, wherein each offset is in-plane with a plane of channels.

5. The heat exchanger of claim 4, wherein each offset is in a plane of channels orthogonal to the linear alignment of the open ends of the channels.

6. The heat exchanger of claim 1, wherein the body is formed of a metal.

7. The heat exchanger of claim 1, further comprising a heat exchange fluid within the channels.

8. The heat exchanger of claim 1, further comprising a first heat exchange fluid within the first set of channels, and a second heat exchange fluid with the second set of channels.

9. The heat exchanger of claim 1, wherein the first chamber of the first header is subdivided into an inlet chamber and an outlet chamber, and the second chamber of the first header is subdivided into an inlet chamber and an outlet chamber.

10. A method of manufacturing the heat exchanger of claim 1, comprising:
extruding a longitudinally extending intermediate piece, the intermediate piece including a plane of channels extending longitudinally therethrough;
cutting the extruded intermediate piece into a plurality of segments;
forming the offset at the end portions of each segment;
stacking the segments such that the checkerboard pattern is present in the central span and the channels of each of the first and second sets are linearly aligned within the first and second end portions;
joining segments in the stack to form the body of the heat exchanger;
removing sections of the end portions of alternating planes of channels orthogonal to the offsets;
attaching the first header and the second header to the first and second end portions.

11. The method of claim 10, wherein the segments in the stack are joined by brazing or welding.

12. The method of claim 10, wherein the sections of the end portions are removed by machining.

13. The method of claim 10, wherein the first and second headers are attached by brazing or welding.

14. A method of manufacturing a heat exchanger, comprising:
extruding a material into a longitudinally extending body piece, a plurality of channels aligned in parallel extending through the body;
cutting the longitudinally extending body piece into a plurality of segments;
bending each segment at opposite ends within a plane through the aligned channels to form an offset at each end;
stacking the segments into a stack with the offsets of each plane arranged in alternating directions, the plurality of channels aligned in parallel within a central span;
joining the segments in the stack to form an integral body;
removing sections of the end portions of alternating linear alignments of channels; and
attaching a first header at one end of the integral body and a second header at another end of the integral body.

15. The method of claim 14, wherein the segments in the stack are joined to form an integral body by brazing or welding.

16. The method of claim 14, wherein the sections of the end portions are removed by machining.

17. The method of claim 14, wherein the first and second headers are attached by brazing or welding.
